(19) United States
(12) Patent Application Publication
(10) Pub. No.: US 2005/0163310 A1
(43) Pub. Date: Jul. 28, 2005

(54) Communication device keypad illumination

(76) Inventors: Louis J. Lundell, Buffalo Grove, IL (US); Rick Latella, Woodstock, IL (US); Matthew C. Loppnow, Pleasant Prairie, WI (US)

Correspondence Address: MOTOROLA INC, 600 NORTH US HIGHWAY 45, ROOM AS437, LIBERTYVILLE, IL, 60048-5343, US

(21) Appl. No.: 10/766,088

(22) Filed: Jan. 27, 2004

(51) Int. Cl. H04M 1/00; H04M 9/00

(52) U.S. Cl. 379/433.07

(57) ABSTRACT

Communication device keypad illumination. A mobile communication device can include a housing and a mobile communication device numeric keypad coupled to the housing, the mobile communication device numeric keypad having an external visible portion. The mobile communication device can also include a light source coupled to the housing, the light source dedicated to direct light substantially at the external visible portion of the mobile communication device numeric keypad to illuminate the mobile communication device numeric keypad.

### BACKGROUND

1. Field

The present disclosure is directed to communication device keypad illumination. More particularly, the present disclosure is directed to illumination of a cellular phone numeric keypad.

2. Description of Related Art

Presently, mobile communication devices, such as cellular phones, personal digital assistants, and the like, allow users to engage in voice and other communications in a variety of settings. Because of this versatility, a user may desire to engage in a communication in a setting with low light. For example, a user may wish to place a call in the outdoors at night or in some other low light setting. To allow a user to see a keypad of a mobile communication device in a low light setting, many mobile communication devices use keypad backlighting techniques. For example, a mobile communication device may use a transparent keypad with a light source behind the keypad to illuminate the keypad. To adequately and evenly illuminate all of the keys on the keypad, the mobile communication device must contain numerous light sources and/or light guides.

Unfortunately, these light sources and light guides take up precious space within the mobile communication device. This can be especially problematic due to the desire to reduce the size of a mobile communication device while increasing its functionality. Furthermore, backlit keypads create the additional problem of limiting materials used for the keypad to transparent and semi-transparent materials.

Thus, there is a need for improved mobile communication device keypad illumination.

### BRIEF DESCRIPTION OF THE DRAWINGS

The embodiments of the present invention will be described with reference to the following figures, wherein like numerals designate like elements, and wherein:

FIG. 1 is an exemplary illustration of a mobile communication device according to one embodiment;

FIG. 2 is an exemplary illustration of a mobile communication device according to another embodiment;

FIG. 3 is an exemplary illustration of a mobile communication device in an open position according to another embodiment;

FIG. 4 is an exemplary illustration of the mobile communication device in a closed position according to another embodiment;

FIG. 5 is an exemplary illustration of a mobile communication device according to another embodiment;

FIG. 6 is an exemplary illustration of a mobile communication device according to another embodiment; and

FIG. 7 is a side cutaway view of a mobile communication device according to another embodiment.

### DETAILED DESCRIPTION

The disclosure provides for communication device keypad illumination. According to one embodiment the present disclosure provides a mobile communication device. The mobile communication device can include a housing, a mobile communication device numeric keypad coupled to the housing, the mobile communication device numeric keypad having an external visible portion. The mobile communication device can also include a light source coupled to the housing, the light source dedicated to direct light substantially at the external visible portion of the mobile communication device numeric keypad to illuminate the mobile communication device numeric keypad. The mobile communication device numeric keypad can have a ultraviolet reactive portion and the light source can be an ultraviolet light source. The ultraviolet reactive portion can include a fluorescent dye coupled to the mobile communication device numeric keypad. The mobile communication device can also include a first housing, a hinge coupled to the first housing, and a second housing coupled to the hinge, where the mobile communication device numeric keypad can be coupled to the first housing and the light source can be coupled to the second housing. The mobile communication device can further include a display coupled to the second housing and a speaker coupled to the second housing. The light source can be an incandescent light source or a light emitting diode light source.

The mobile communication device can additionally include a reflective ring coupled to the housing, the reflective ring substantially surrounding the mobile communication device numeric keypad. The reflective ring can be configured to reflect light from the light source onto the mobile communication device numeric keypad. The reflective ring can cover the light source.

The mobile communication device numeric keypad can be an opaque mobile communication device numeric keypad. The mobile communication device can also include a first housing, a hinge section coupled to the first housing, the hinge section including a pivot housing, and a second housing coupled to the hinge section where the mobile communication device numeric keypad is coupled to the first housing and the light source is coupled to the pivot housing.

The mobile communication device can further include a first housing, a hinge section coupled to the first housing, the hinge section including a pivot housing, and a second housing coupled to the hinge section, the second housing including a second housing hinge section including the light source, the second housing hinge section configured to expose the light source to an external portion of the mobile communication device when the first housing is closed against the second housing. The light source can include a laser pointer.

According to another embodiment, the present disclosure provides a cellular phone. The cellular phone can include a housing, a cellular phone numeric keypad coupled to the housing, the cellular phone numeric keypad having an external visible portion, the external visible portion including an ultraviolet reactive portion, and an ultraviolet light source coupled to the housing, the ultraviolet light source dedicated to direct light substantially directly at the external visible portion of the cellular phone numeric keypad to illuminate the cellular phone numeric keypad. The ultraviolet reactive portion can include a fluorescent dye coupled to the cellular phone numeric keypad. The cellular phone can also include a first housing, a hinge coupled to the first housing, and a second housing coupled to the hinge, where the cellular phone numeric keypad is coupled to the first housing and the ultraviolet light source is coupled to the second housing. The cellular phone can additionally include a display coupled to the second housing and a speaker coupled to the second housing. The ultraviolet light source can be an incandescent ultraviolet light source or a light emitting diode ultraviolet light source. The cellular phone can further include a reflective ring coupled to the housing, the reflective ring substantially surrounding the cellular phone numeric keypad, the reflective ring configured to reflect light from the ultraviolet light source onto a face of the cellular phone numeric keypad. The cellular phone numeric keypad can include a substantially opaque cellular phone numeric keypad. The cellular phone can also include a first housing, a hinge coupled to the first housing, and a second housing coupled to the hinge, where the cellular phone numeric keypad can be coupled to the first housing and the ultraviolet light source can be coupled to the hinge. The ultraviolet light source can be configured to emit light at a wavelength from substantially 380 nm to substantially 405 nm.

According to another embodiment, the present disclosure provides a cellular phone. The cellular phone can include a housing, a display coupled to the housing, a controller coupled to the display, and an opaque cellular phone numeric keypad coupled to the housing and the controller, the opaque cellular phone numeric keypad including an external visible portion, the external visible portion comprising an ultraviolet reactive portion including a fluorescent dye. The cellular phone can also include an ultraviolet light source coupled to the controller and coupled to the housing, the ultraviolet light source dedicated to direct light substantially at the external visible portion of the opaque cellular phone numeric keypad to illuminate the opaque cellular phone numeric keypad. The controller can be configured to control the operation of the ultraviolet light source.

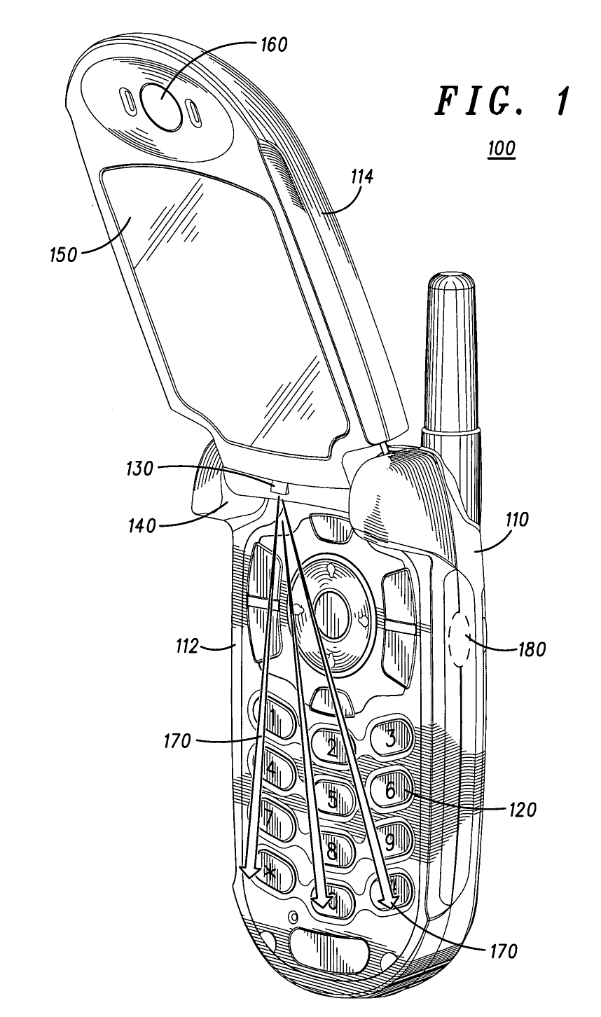

FIG. 1 is an exemplary illustration of a mobile communication device 100 according to one embodiment. The mobile communication device 100 according to this embodiment and all other disclosed embodiments may be a cellular phone such as a single housing candy bar-style cellular phone, a dual housing flip-style cellular phone, a cellular phone with a rotating faceplate, or any other cellular phone. The mobile communication device 100 may also be a wireless phone, a personal digital assistant, a pager, a wireless telephone or any other mobile communication device. The mobile communication device 100 may include a housing 110, a mobile communication device numeric keypad 120, at least one light source 130, a hinge section 140, a display 150, a speaker 160, and a controller 180. The housing 110 may include a first housing 112 and a second housing 114. The mobile communication device numeric keypad 120 may be a cellular phone numeric keypad and can include all keys necessary to make a telephone-style call along with additional function keys for operating the mobile communication device 100. For example, the keypad 120 can include a navigational button, key, or pad, a send key, a end key, and other selection keys.

The light source 130 can be located anywhere on the mobile communication device 110 where it can provide light to the face of the keypad 120. According to this embodiment, the light source 130 can be located on the second housing 114 below the display 150. As another example, the light source 130 can be located below the display of a unitary housing candy-bar style phone. The light source 130 can be a light emitting diode, an incandescent light source, a fiber optic output coupled to a display light source, or any other useful light source. The light source 130 can utilize lightguiding features to distribute substantially all of the light 170 to the keypad 120. For example, the light source 130 can employ reflectors, diffusers, and the like to distribute substantially all of the light 170 to the keypad 120. The light source may be any useful color light source, such as red, white, green, blue, or the like. The keypad 120 can be a substantially opaque keypad and may include printed graphics or laser etchings that can produce sufficient contrast for viewing the keypad 120 in low light conditions. Additionally, the light source 130 can be an ultraviolet light source such as a blacklight, a dark purple light source, or the like. For example, the light source 130 can supply light at a wavelength from substantially 380 nm to substantially 405 nm. Thus, the keypad 120 may employ an ultraviolet reactive portion such as fluorescent dye inks that respond to the ultraviolet radiation and produce a glowing effect for readability in low light conditions. The keypad 120 may also employ a phosphorescent portion. For example, the keypad may use an ink that continues to glow after being briefly illuminated by the light source 130. The hinge section 140 can provide a pivot for the first housing 112 and the second housing 114 when opening and closing the mobile communication device 100. The controller 180 can be included within the housing 110 and thus, may not be visible.

In operation, the controller 180 controls the operations of the mobile communication device 100. For example, the controller 180 can control the transmission and reception of signals by the mobile communication device 100 on a wireless network. The controller 180 can also receive input signals from the keypad 120. The controller 180 can additionally control the operation of the light source 130. In particular, the controller 180 can enable the light source 180 to direct light 170 substantially at the keypad 120.

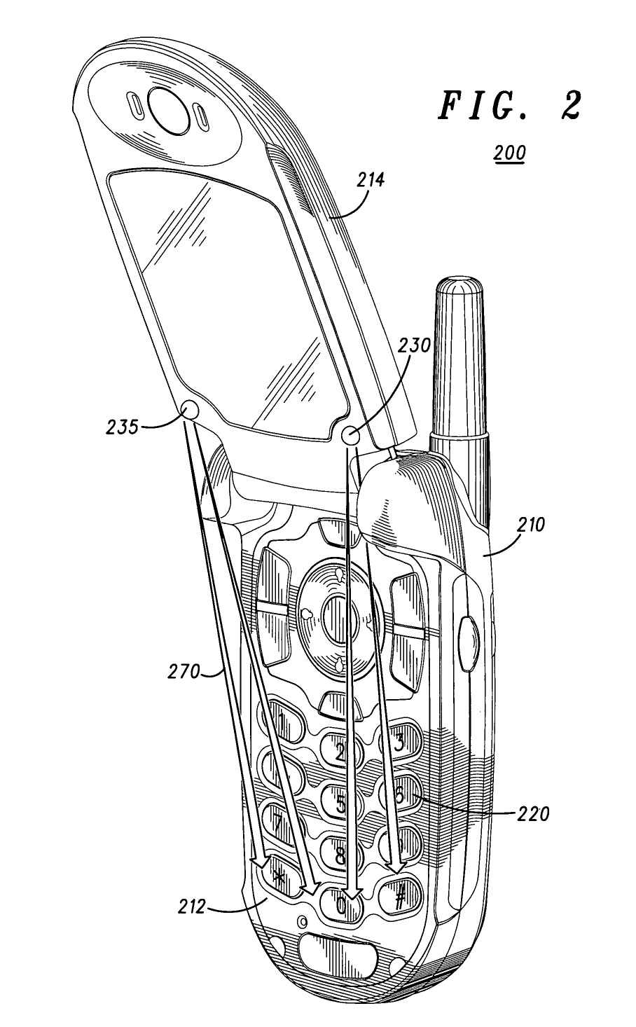

FIG. 2 is an exemplary illustration of a mobile communication device 200 according to another embodiment. Many of the features of the mobile communication device 200 can be similar to any of the other disclosed mobile communication devices. The mobile communication device 200 illustrates two light sources for illuminating a numeric keypad 220. In particular, The mobile communication device 200 can include a housing 210 including a first housing 212 and a second housing 214. The second housing 214 can include a first light source 230 and a second light source 235 used to distribute light to a mobile communication device numeric keypad 220 located on the first housing 212.

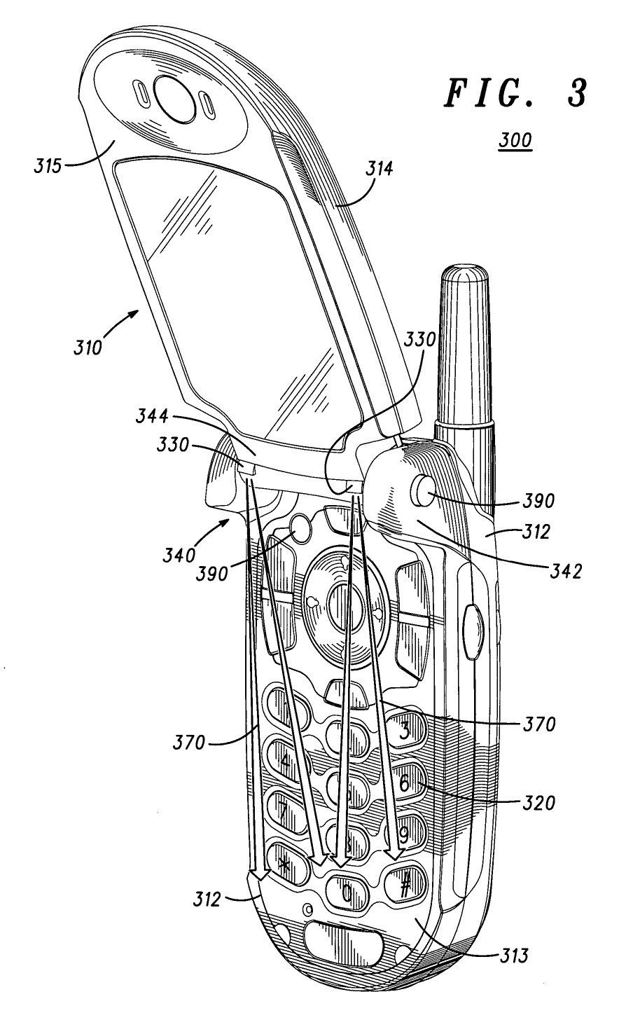

FIG. 3 is an exemplary illustration of a mobile communication device 300 in an open position according to another embodiment. Many of the features of the mobile communication device 300 can be similar to any of the other disclosed mobile communication devices. For example, the mobile communication device 300 can include a housing 310. The housing 310 can include a first housing 312, a second housing 314, and a hinge section 340. The hinge section 340 can include a pivot housing 342. The first housing 312 can include a first housing face 313. The second housing 314 can include a second housing face 315 and a second housing section of the hinge section 340. The mobile communication device 300 can also include a mobile communication device numeric keypad 320, at least one light source 330 coupled to the second housing section 344 of the hinge section 340, and a light actuation button 390. The light actuation button 390 can be used to signal the controller 180 (not shown) to activate the light source 330. Upon actuation of the light actuation button 390 or upon any other useful event for actuating the light source, the at least one light source 330 can distribute light 370 to the numeric keypad 370 when the mobile communication device 300 is in the open position.

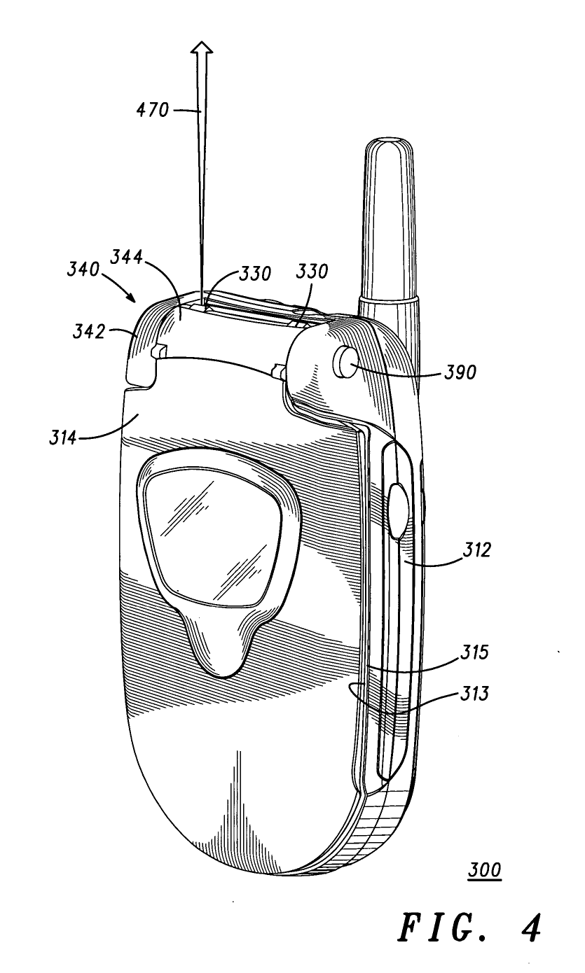

FIG. 4 is an exemplary illustration of the mobile communication device 300 in a closed position according to another embodiment. As illustrated, the second housing section 344 can be configured to expose the light source 330 external to the mobile communication device 300 when the first housing face 313 is closed against the second housing face 315. In the closed position, the light source 330 can distribute light 470 external to the mobile communication device 300. For example, the light actuation button 390 can be used to turn on the light source 330 when the mobile communication device 300 is in a closed position. The light source 330 can include multiple light sources. According to one embodiment, the light source 330 can include both a light emitting diode and an incandescent light source. One light source can be activated to illuminate the keypad 320 and one light source can be used to direct light external to the mobile communication device 200. According to another embodiment, the light source can include a laser that can operate as a laser pointer when the mobile communication device 300 is in a closed position. The keypad 320 can then be coated with a dye that reacts to the laser when the mobile communication device 300 is in an open position. According to another embodiment, the light source 330 only utilizes one type of light to both illuminate the keypad 320 when the mobile communication device 300 is in the open position and to direct light external to the mobile communication device 300 when the mobile communication device 300 is in the closed position.

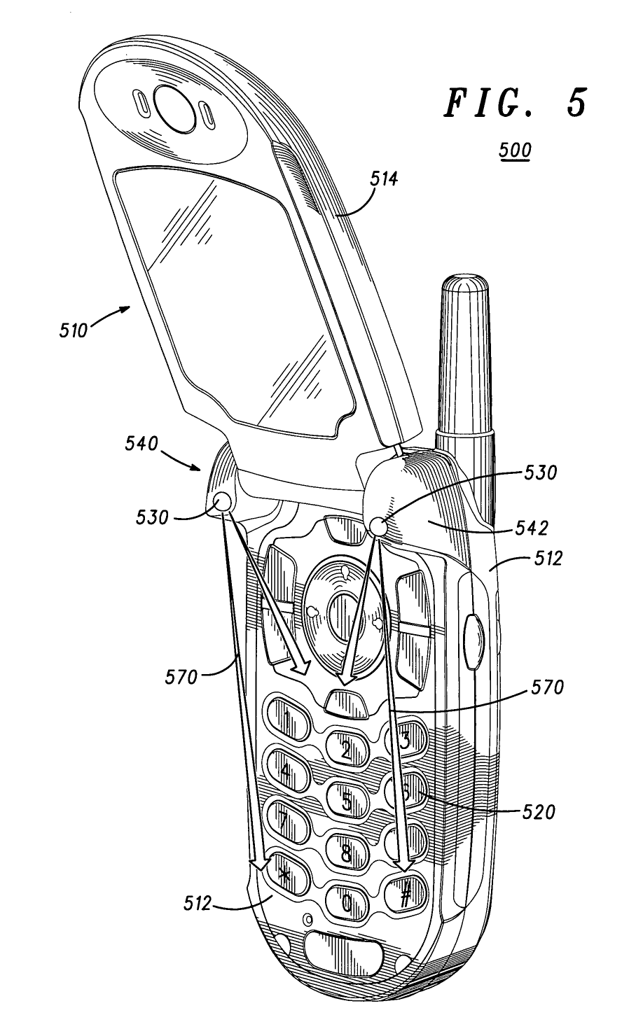

FIG. 5 is an exemplary illustration of a mobile communication device 500 according to another embodiment. Many of the features of the mobile communication device 500 can be similar to any of the other disclosed mobile communication devices. For example, the mobile communication device 500 can include a housing 510 having a first housing 512 and a second housing 514. The mobile communication device 500 can also include a hinge section 540 having a pivot housing 542 that encloses a pivot mechanism for rotating the second housing 514 about the first housing 512. The pivot housing 542 can be fixed to the first housing 512 meaning the pivot housing 542 does not move relative to the first housing 512 when the second housing 514 moves. The mobile communication device 500 can further include at least one light source 530 and a keypad 520. The light source 530 can be coupled to the pivot housing 542 of the hinge section 540. Thus, the light source 530 does not rotate along with the second housing 514 relative to the first housing 512. According to another embodiment, the light source is coupled directly to the first housing 512.

FIG. 6 is an exemplary illustration of a mobile communication device 600 according to another embodiment. Many of the features of the mobile communication device 600 can be similar to any of the other disclosed mobile communication devices. For example, the mobile communication device 600 may be a unitary housing candy bar-style cellular phone, a flip-style cellular phone, or any other mobile communication device. The mobile communication device 600 can include a housing 610, a mobile communication device keypad 620, and a reflective ring 635. The reflective ring 635 can substantially surround the keypad 620. For example, the reflective ring 635 can sufficiently surround the keypad 620 to sufficiently reflect light 670 to illuminate the entire keypad 620. According to another embodiment, the reflective ring 635 can substantially entirely surround the keypad 620. For example, the reflective ring 635 can surround the majority or all of the keypad 620.

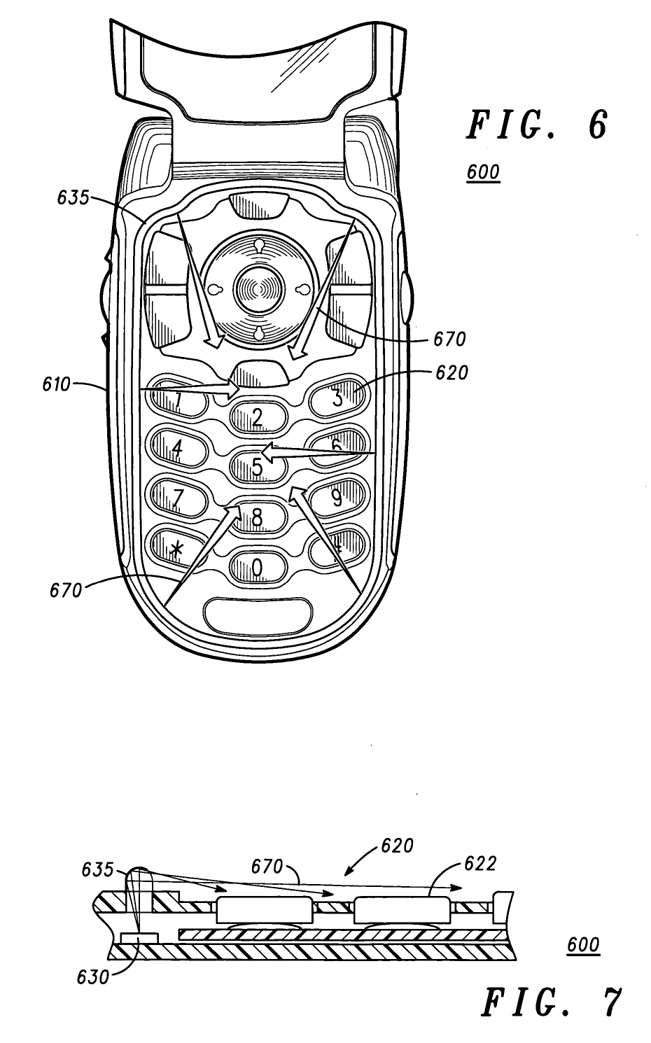

FIG. 7 is a side cutaway view of the mobile communication device 600 according to another embodiment. The cutaway view includes a light source 630, a reflective ring 635, and a mobile communication device numeric keypad 620. The keypad 620 can have an external visible portion 622 which can include an ultraviolet light reactive portion including a fluorescent dye. In operation, the light source 630 can direct light 670 directly to the face of the external visible portion 622. That is to say, the light source 630 does not direct light through the keypad 620 from a side opposite from the external visible portion 622. For example, the light source 630 can transmit light 670 to the reflective ring 635. The reflective ring 635 can reflect the light 670 directly to the external visible portion 622 of the keypad 620. The reflective ring 635 can be configured to distribute the light 670 substantially evenly across the numeric keypad 620. Furthermore, the reflecting ring 635 may also be configured to distribute a portion of the light 670 away from the keypad 620 for a decorative effect.

The operations of this invention are preferably implemented on a programmed processor. However, the controller 180 may also be implemented on a general purpose or special purpose computer, a programmed microprocessor or microcontroller and peripheral integrated circuit elements, an ASIC or other integrated circuit, a hardware electronic or logic circuit such as a discrete element circuit, a programmable logic device such as a PLD, PLA, FPGA or PAL, or the like. In general, any device on which resides a finite state machine capable of implementing the operations disclosed may be used to implement the processor functions of this invention.

While this invention has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the invention by simply employing the elements of the independent claims. Accordingly, the preferred embodiments of the invention as set forth herein are intended to be illustrative, not limiting. Various changes may be made without departing from the spirit and scope of the invention.

1. A mobile communication device, comprising:
a housing;
a mobile communication device numeric keypad coupled to the housing, the mobile communication device numeric keypad having an external visible portion; and
a light source coupled to the housing, the light source dedicated to direct light substantially directly at the external visible portion of the mobile communication device numeric keypad to illuminate the mobile communication device numeric keypad.

2. The mobile communication device according to claim 1,
wherein the mobile communication device numeric keypad comprises a ultraviolet reactive portion, and
wherein the light source comprises an ultraviolet light source.

3. The mobile communication device according to claim 2, wherein the ultraviolet reactive portion comprises a fluorescent dye coupled to the mobile communication device numeric keypad.

4. The mobile communication device according to claim 1, further comprising:
a first housing;
a hinge coupled to the first housing; and
a second housing coupled to the hinge,
wherein the mobile communication device numeric keypad is coupled to the first housing, and
wherein the light source is coupled to the second housing.

5. The mobile communication device according to claim 4, further comprising:
a display coupled to the second housing; and
a speaker coupled to the second housing.

6. The mobile communication device according to claim 1, wherein the light source is at least one of an incandescent light source and a light emitting diode light source.

7. The mobile communication device according to claim 1, further comprising a reflective ring coupled to the housing, the reflective ring substantially surrounding the mobile communication device numeric keypad, the reflective ring configured to reflect light from the light source onto a face of the mobile communication device numeric keypad.

8. The mobile communication device according to claim 1, wherein the reflective ring covers the light source.

9. The mobile communication device according to claim 1, wherein the mobile communication device numeric keypad comprises an opaque mobile communication device numeric keypad.

10. The mobile communication device according to claim 1, further comprising:
a first housing;
a hinge section coupled to the first housing, the hinge section including a pivot housing; and
a second housing coupled to the hinge section,
wherein the mobile communication device numeric keypad is coupled to the first housing, and
wherein the light source is coupled to the pivot housing.

11. The mobile communication device according to claim 1, further comprising:
a first housing;
a hinge section coupled to the first housing, the hinge section including a pivot housing; and
a second housing coupled to the hinge section, the second housing including a second housing hinge section including the light source, the second housing hinge section configured to expose the light source external to the mobile communication device when the first housing is closed against the second housing.

12. The mobile communication device according to claim 11, wherein the light source comprises a laser pointer.

13. A cellular phone, comprising:
a housing;
a cellular phone numeric keypad coupled to the housing, the cellular phone numeric keypad having an external visible portion, the external visible portion comprising an ultraviolet reactive portion; and
an ultraviolet light source coupled to the housing, the ultraviolet light source dedicated to direct light substantially directly at the external visible portion of the cellular phone numeric keypad to illuminate the cellular phone numeric keypad.

14. The cellular phone according to claim 13, wherein the ultraviolet reactive portion comprises a fluorescent dye coupled to the cellular phone numeric keypad.

15. The cellular phone according to claim 13, further comprising:
a first housing;
a hinge coupled to the first housing; and
a second housing coupled to the hinge,
wherein the cellular phone numeric keypad is coupled to the first housing, and
wherein the ultraviolet light source is coupled to the second housing.

16. The cellular phone according to claim 13, further comprising:
a display coupled to the second housing; and
a speaker coupled to the second housing.

17. The cellular phone according to claim 13, wherein the ultraviolet light source is at least one of an incandescent ultraviolet light source and a light emitting diode ultraviolet light source.

18. The cellular phone according to claim 13, further comprising a reflective ring coupled to the housing, the reflective ring substantially surrounding the cellular phone numeric keypad, the reflective ring configured to reflect light from the ultraviolet light source onto the cellular phone numeric keypad.

19. The cellular phone according to claim 13, wherein the cellular phone numeric keypad comprises a substantially opaque cellular phone numeric keypad.

20. The cellular phone according to claim 13, further comprising:
a first housing;
a hinge coupled to the first housing; and
a second housing coupled to the hinge,
wherein the cellular phone numeric keypad is coupled to the first housing, and
wherein the ultraviolet light source is coupled to the hinge.

21. The cellular phone according to claim 13, wherein the ultraviolet light source is configured to emit light at a wavelength from substantially 380 nm to substantially 405 nm.

22. A cellular phone, comprising:
a housing;
a display coupled to the housing;
a controller coupled to the housing;
an opaque cellular phone numeric keypad coupled to the housing and the controller, the opaque cellular phone numeric keypad including an external visible portion,
the external visible portion comprising an ultraviolet reactive portion including a fluorescent dye; and
an ultraviolet light source coupled to the controller and coupled to the housing, the ultraviolet light source dedicated to direct light substantially directly at the external visible portion of the opaque cellular phone numeric keypad to illuminate the opaque cellular phone numeric keypad,
wherein the controller is configured to control the operation of the ultraviolet light source.
